(19) United States
(12) Patent Application Publication
(10) Pub. No.: US 2017/0269666 A1
(43) Pub. Date: Sep. 21, 2017

(54) Smart Dynamic Voltage and Frequency Scaling of Electronic Components

(71) Applicant: Apple Inc., Cupertino, CA (US)

(72) Inventors: Rohan S. Patil, Cupertino, CA (US); Tatsuya Iwamoto, Cupertino, CA (US); Gokhan Avkarogullari, San Jose, CA (US)

(21) Appl. No.: 15/074,780

(22) Filed: Mar. 18, 2016

(51) Int. Cl. G06F 1/32

(52) U.S. Cl. CPC G06F 1/324

(57) ABSTRACT

Techniques for managing components of a processing system are described. Illustrative components include graphics processing units (GPUs), central processing units (CPUs), communication fabrics, memory controllers, or peripheral control circuits. For one embodiment, a performance control logic/module obtains information associated with components of a system during performance of a task by the system. The logic/module can determine the need to adjust an operational performance of a first component based on the obtained information. The performance control logic/module can also evaluate the obtained information to determine that the operational performance of one or more second components of the system should be adjusted to satisfy the determined need (of the first component). Moreover, the logic/module can adjust a first clock signal affecting the operational performance of the first component and one or more second clock signals affecting the operational performance of the one or more second components.

### FIELD

Embodiments described herein relate to managing electronic components. More particularly, the embodiments described herein relate to dynamic management of power and performance of at least one electronic component of a processing system.

### BACKGROUND INFORMATION

Dynamic voltage and frequency scaling (DVFS) is a power and performance management technique used in computer architecture to provide control of the power and the performance of electronic components, such as processors. DVFS includes the use of at least one of dynamic frequency scaling or dynamic voltage scaling.

Dynamic frequency scaling refers to adjusting the primary operating frequency of an electronic component based upon constraints affecting the component. For example, reducing the operating frequency of a processor results in a reduction in the number of instructions that the processor can perform in a given amount of time which reduces the performance of the processor (and also its power consumption). On the other hand, increasing the frequency can lead to an increase in the number of instructions performed by the processor in a given amount of time which can increase the performance of the processor (and also its power consumption).

Dynamic voltage scaling refers to adjusting the voltage used by an electronic component based on constraints affecting the component. Dynamic voltage scaling to increase voltage is known as overvolting, which can lead to increases in the performance of an electronic component (e.g., a processor, etc.). Dynamic voltage scaling to decrease voltage is known as undervolting, which can decrease the performance of an electronic component (e.g., a processor, etc.).

In some scenarios, DVFS is applied in response to a demand being made on an electronic component (e.g., a processor, etc.). Increasing the voltage and/or frequency used to drive the component can speed up the component's throughput. For example, it is known to increase the driving frequency and/or voltage of a processor when there are tasks waiting in one or more input queues of the processor. Similarly, it is known to reduce the primary clock frequency and/or voltage of a processor when there are few or no tasks waiting in one or more input queues of the processor.

### SUMMARY

Embodiments of methods, apparatuses, and systems for managing a processing system that includes at least two electronic components are described. Such embodiments can assist with intelligently applying DVFS to manage at least one electronic component of a processing system based on constraints affecting at least two components of the system.

For one embodiment, managing a processing system having multiple electronic components can be performed by a performance control logic/module associated with the processing system. For one embodiment, the performance control logic/module obtains information associated with electronic components of a processing system. The components of the system can include at least one of a graphics processing unit (GPU), a central processing unit (CPU), a communication fabric, a memory controller, or a peripheral control circuit. For each component of the system whose information is obtained, the information can include information that is indicative of a workload of the component and a bandwidth of the component.

For one embodiment, managing the processing system also includes the performance control logic/module determining a need to adjust an operational performance of a first component of the processing system. The determination of the need can be based on the obtained information. For one embodiment, managing the processing system includes the performance control logic/module evaluating the obtained information to determine that an operational performance of one or more second components of the processing system should be adjusted to satisfy the determined need. For one embodiment, managing the processing system includes the performance control logic/module adjusting a first clock signal affecting the operational performance of the first component and one or more second clock signals affecting an operational performance of one or more second components of the processing system. The adjustment by the performance control logic/module can be performed in response to the evaluation performed by the performance control logic/module.

Other features or advantages of the embodiments described herein will be apparent from the accompanying drawings and from the detailed description that follows below.

### BRIEF DESCRIPTION OF THE DRAWINGS

Embodiments described herein are illustrated by way of example and not limitation in the figures of the accompanying drawings, in which like references indicate similar features. Furthermore, in the figures some conventional details have been omitted so as not to obscure the inventive concepts described herein.

FIG. 1 is a block diagram of a processing system, which includes electronic components that can be managed in accordance with one embodiment.

FIG. 2 is a block diagram of another processing system, which includes electronic components that can be managed in accordance with one embodiment.

FIG. 3 is a flowchart representing one embodiment of a process of managing electronic components of a processing system.

FIG. 4 is a flowchart representing another embodiment of a process of managing electronic components of a processing system.

FIG. 5 illustrates an exemplary processing system according to one or more of the embodiments described herein.

### DETAILED DESCRIPTION

Embodiments of methods, apparatuses, and systems for managing power and performance of a processing system that includes at least two electronic components are described. Such embodiments can assist with intelligently applying DVFS to at least one of the electronic components in a processing system based on constraints affecting at least two of the components.

As used herein, a “workload of a component” and its variations refer to a number and/or type of operations or transactions that have been, will be, or are currently being performed by one or more processing elements of the component. For example, a workload of a graphics processing unit (GPU) can include at least one of the following: (i) a number of pending operations or transactions to be performed by the processing elements of the GPU; (ii) a number of past operations or transactions that have already been performed by the processing elements of the GPU; or (iii) a number of current operations or transactions that are currently being performed by the processing elements of the GPU.

As used here, a “bandwidth of a component” and its variations refer to a rate of data transfer associated with the component that is measured over a period of time (e.g., a second, a millisecond, a minute, etc.). The bandwidth can, for example, be measured in bits per second or bytes per second. The rate of data transfer associated with the component includes at least one of a rate of data being transferred out of the component or a rate of data being transferred into the component. For example, the bandwidth of a GPU can include at least one of: (i) a rate of data being transferred into the GPU; or (ii) a rate of data being transferred out of the GPU.

For one embodiment, managing a processing system having electronic components includes obtaining information associated with the components. Management of the processing system may also include determining a need to adjust an operational performance of a first component of the system. The need can be determined based on the obtained information. For one embodiment, the management of the processing system may also include evaluating the obtained information to determine that an operational performance of one or more second components of the processing system should be adjusted to satisfy the determined need. For one embodiment, the management of the processing system may also include adjusting a first clock signal affecting the operational performance of the first component and one or more second clock signals affecting the operational performance(s) of one or more second components of the processing system. The adjustment can be performed based on the evaluation.

In at least one currently available processing system, DVFS is applied to a component (e.g., a processor, etc.) in that system based solely on the demands placed on that component, without regard for the demands and/or operating conditions of any other components in the system. This technique of applying DVFS can lead to wasted resources, which can result in suboptimal power consumption and performance by the components in the system. The shortcomings of this technique can be illustrated with an example of a computing system that includes a graphics processing unit (GPU) in communication with memory storing data to be accessed by the GPU. In this example, the frequency of a clock signal used to operate the GPU may be directly proportional to the number of tasks queued for the GPU to execute. That is, as more tasks are queued for the GPU, the frequency of the GPU clock is increased in an attempt to improve the performance of the GPU. Moreover, as fewer tasks are queued for the GPU, the operating frequency of the GPU is decreased. This simple model relates a GPU's operating frequency with its throughput. Nevertheless, increasing a GPU's primary operating frequency does not always lead to improved performance. For example, even if there are many tasks queued for the GPU to process, if the GPU is memory bound (i.e., stalled waiting for memory transactions to complete), increasing the GPU's operating frequency may not necessarily increase GPU performance. In such a situation, the increased GPU clock frequency may have the undesirable drawback of increasing the GPU's thermal output and, for battery operated devices, reducing battery life.

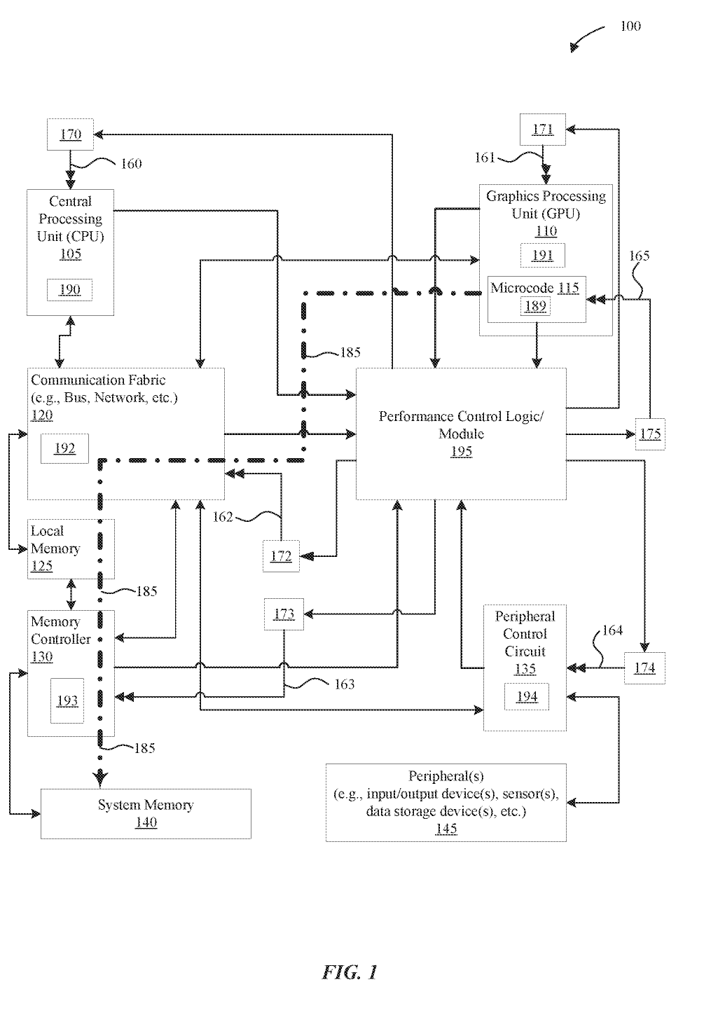

FIG. 1 is a block diagram of a processing system 100 including electronic components 105, 110, 120, 130, and 135 that can be managed in accordance with one embodiment. For one embodiment, the system 100 may include at least one of a central processing unit (CPU) 105, a graphics processing unit (GPU) 110, a communication fabric 120, a memory controller 130, or a peripheral control circuit 135. The system 100 can also include performance control logic/module 195 for managing at least one of the CPU 105, the GPU 110, the communication fabric 120, the memory controller 130, or the peripheral control circuit 135.

Furthermore, the system 100 can include memory for storing and/or retrieving data associated with at least one of the CPU 105, the GPU 110, the communication fabric 120, the memory controller 130, the peripheral control circuit 135, or the performance control logic/module 195. For one embodiment, the memory of system 100 includes at least one of a local memory 125 or a system memory 140.

The system 100 can include peripheral(s) 145. For one embodiment, these peripheral(s) 145 can include at least one of the following: (i) one or more input devices which interact with or send data to the system 100 (e.g., mouse, keyboards, etc.); (ii) one or more output devices which provide output from the system 100 (e.g., monitors, printers, etc.); or (iii) one or more storage devices which store data in addition to the local memory 125 and/or the system memory 140. At least one peripheral(s) 145 may combine different devices into a single hardware component that can be used both as an input and output device (e.g., a touchscreen, etc.). Peripheral(s) 145 may also be referred to as input/output (I/O) devices 145 throughout this document.

For one embodiment, the peripheral(s) 145 of system 100 may also include at least one sensor whose purpose is to detect a characteristic of one or more environs. Examples of a sensor include, but are not limited to, an optical activity sensor, an optical sensor array, an imaging sensor, a video sensor, an accelerometer, a sound sensor, a barometric sensor, a proximity sensor, an ambient light sensor, a vibration sensor, a gyroscopic sensor, a compass, a barometer, a magnetometer, a voltage sensor, a current sensor, a resistance sensor, a thermistor sensor, an electrostatic sensor, a frequency sensor, a temperature sensor, a heat sensor, a thermostat, a thermometer, a light sensor, a differential light sensor, an opacity sensor, a scattering light sensor, a diffractional sensor, a refraction sensor, a reflection sensor, a polarization sensor, a phase sensor, a florescence sensor, a phosphorescence sensor, a micro mirror array, a pixel array, a micro pixel array, a rotation sensor, a velocity sensor, an inclinometer, a pyranometer, and a momentum sensor.

For one embodiment, one or more components of the system 100 may be implemented as one or more integrated circuits (ICs). For example, at least one of the CPU 105, the GPU 110, the communication fabric 120, the memory controller 130, the peripheral control circuit 135, or the performance control logic/module 195 can be implemented as a system-on-a-chip (SoC) IC, a three-dimensional (3D) IC, any other known IC, or any known combination of ICs. For another embodiment, two or more of components of the system 100 are implemented together as one or more ICs. For example, the CPU 105, the GPU 110, the communication fabric 120, the memory controller 130, and the peripheral control circuit 135 are implemented together as a single SoC IC.

As shown in FIG. 1, the system 100 can include a CPU 105. For one embodiment the CPU 105 is electronic circuitry for carrying out one or more instructions of a computer program by performing the arithmetic, logical, control and input/output (I/O) operations specified by the instructions. The CPU 105 can include several processing elements 190. For one embodiment, the processing elements 190 can include at least one arithmetic logic unit (ALU) that performs arithmetic and logic operations, at least one register that supplies operands to the ALU(s) and stores the results of ALU operations, and at least one control unit that fetches instructions from memory and executes them by directing the coordinated operations of the ALU, registers, and other components (e.g., counters, etc.) of the CPU 105.

For one embodiment, the CPU 105 includes one or more circuits, which employ a clock signal 160 to pace their operations. For this embodiment, the clock signal 160 used to pace the operations of the CPU 105 is produced by an electronic oscillator 170, which is an electronic circuit that produces an oscillating electronic signal. The clock signal 160 produced by the oscillator 170 can be generated as a consistent number of pulses over a period of time (e.g., every second, etc.) in the form of a waveform (e.g., a sinusoidal waveform, a non-sinusoidal waveform, etc.). The frequency of the clock signal 160 generated by the oscillator 170 determines the rate at which the CPU 105 executes instructions and, consequently, the higher the frequency of the clock signal 160, the more instructions the CPU 105 can execute over a period of time (e.g., each second, etc.).

The GPU 110 of the system 100 is similar to the CPU 105; however, the GPU 110 includes specialized electronic circuits designed for manipulating computer graphics and/or performing image processing. The circuits of the GPU 110 can operate by manipulating and altering memory to accelerate the creation of images in a frame buffer intended for an output device (e.g., a display device, etc.). Similar to the CPU 105, the GPU 110 can include several processing elements 191. For one embodiment, the processing elements 191 include at least one ALU, at least one register, and at least one control unit that fetches instructions from memory and executes them by directing the coordinated operations of the ALU, registers, and other components (e.g., counters, etc.) of the GPU 110.

For one embodiment, the GPU 110 includes one or more circuits, which employ a clock signal 161 to pace their operations. For this embodiment, the clock signal 161 used to pace the operations of the GPU 110 is produced by an electronic oscillator 171. The clock signal 161 produced by the oscillator 171 can be generated as a consistent number of pulses over a period of time (e.g., every second, etc.) in the form of a waveform (e.g., a sinusoidal waveform, a non-sinusoidal waveform, etc.). The frequency of the clock signal 161 determines the rate at which the GPU 110 executes instructions and, consequently, the higher the frequency of the clock signal 161, the more instructions the GPU 110 will execute over a period of time (e.g., each second, etc.).

The GPU 110 can also include a microcode engine 115, which assembles and/or processes a layer of hardware-level instructions that implement higher-level machine code instructions or internal state machine sequencing in the GPU 110. For one embodiment, the microcode engine 115 translates machine instructions, state machine data, and/or other GPU input into sequences of detailed circuit-level operations for the GPU 110. The microcode engine 115 can include several processing elements 189. For one embodiment, the processing elements 189 include at least one ALU, at least one register, and at least one control unit that fetches instructions from memory and executes them by directing the coordinated operations of the ALU, registers, and other components (e.g., counters, etc.) of the microcode engine 115. For one embodiment, the microcode engine 115 includes one or more circuits, which employ a clock signal 165 to pace their operations. For this embodiment, the clock signal 165 used to pace the operations of the microcode engine 115 is produced by an electronic oscillator 175. The clock signal 165 can be generated as a consistent number of pulses over a period of time (e.g., every second, etc.) in the form of a waveform (e.g., a sinusoidal waveform, a non-sinusoidal waveform, etc.). The frequency of the clock signal 165 determines the rate at which the microcode engine 115 executes instructions for the GPU 110 and, consequently, the higher the frequency of the clock signal 165, the more instructions the microcode engine 115 executes instructions for the GPU 110 over a period of time (e.g., each second, etc.).

The system 100 can also include a memory controller 130, which includes at least one electronic circuit that manages the flow of data going to and from the system memory 140 and/or the local memory 125. The memory controller 130 can be a separate IC or integrated into another IC, such as being placed on the same die or as an integral part of a microprocessor. The memory controller 130 can include several processing elements 193. For one embodiment, the processing elements 193 include at least one ALU, at least one register, and at least one control unit that fetches instructions from memory and executes them by directing the coordinated operations of the ALU, registers, and other components (e.g., counters, etc.) of the memory controller 130.

For one embodiment, the memory controller 130 includes one or more circuits, which employ a clock signal 163 to pace their operations. For this embodiment, the clock signal 163 used to pace the operations of the memory controller 130 is produced by an electronic oscillator 173. The clock signal 163 produced by the oscillator 173 can be generated as a consistent number of pulses over a period of time (e.g., every second, etc.) in the form of a waveform (e.g., a sinusoidal waveform, a non-sinusoidal waveform, etc.). The frequency of the clock signal 163 determines the rate at which the memory controller 130 executes instructions and, consequently, the higher the frequency of the clock signal 163, the more instructions the memory controller 130 will execute over a period of time (e.g., each second, etc.).

One or more peripheral control circuits 135 can be part of the system 100. For one embodiment, each of the one or more peripheral control circuits 135 can be a controller (e.g., a chip, an expansion card, or a stand-alone device, etc.) that interfaces with and is used to direct operation of the peripheral(s) 145. Similar to the memory controller 130, each of the one or more peripheral control circuits 135 can be a separate IC or integrated into another IC, such as being placed on the same die or as an integral part of a microprocessor. Each of the one or more peripheral control circuits 135 can include several processing elements 194. For one embodiment, the processing elements 194 include at least one ALU, at least one register, and at least one control unit that fetches instructions from memory and executes them by directing the coordinated operations of the ALU, registers, and other components (e.g., counters, etc.) of the peripheral control circuit 135.

For one embodiment, each of the one or more peripheral control circuits 135 includes one or more circuits, which employ one or more clock signals 164 to pace their operations. For this embodiment, the clock signal(s) 164 used to pace the operations of the peripheral control circuit(s) 135 are produced by one or more electronic oscillators 174. Each of the one or more clock signals 164 produced by the oscillator(s) 174 can be generated as a consistent number of pulses over a period of time (e.g., every second, etc.) in the form of a waveform (e.g., a sinusoidal waveform, a non-sinusoidal waveform, etc.). The frequency of the clock signal(s) 164 determines the rate at which a respective one of the one or more peripheral control circuits 135 executes instructions and, consequently, the higher the frequency of the clock signal(s) 164, the more instructions the respective peripheral control circuit 135 will execute over a period of time (e.g., each second, etc.).

For one embodiment, the system 100 includes a communication fabric 120. The communication fabric 120 can be a bus or a network. When the fabric 120 is a bus, the fabric 120 is a communication system that transfers data between components inside system 100, or between components of system 100 and other components of other systems (not shown). As a bus, the fabric 120 includes all related hardware components (wire, optical fiber, etc.) and software, including communication protocols. For one embodiment, the fabric 120 can include at least one of an internal bus or an external bus. Moreover, the fabric 120 can include at least one of a control bus, an address bus, or a data bus for communications associated with the system 100.

For one embodiment, the fabric 120 can be a network or a switch. As a network, the fabric 120 may be any type of network such as a local area network (LAN), a wide area network (WAN) such as the Internet, a fiber network, a storage network, or a combination thereof, wired or wireless. When the fabric 120 is a network, the components of the system 100 do not have to be physically located next to each other. When the fabric 120 is a switch (e.g., a “cross-bar” switch), separate components of system 100 may be linked directly over a network even though these components may not be physically located next to each other. For example, two or more of the CPU 105, the GPU 110, the communication fabric 120, the memory controller 130, the peripheral control circuit 135, and the performance control logic/module 195 are in distinct physical locations from each other and are communicatively coupled via the communication fabric 120, which is a network or a switch that directly links these components over a network.

The fabric 120 can include several processing elements 192. For one embodiment, the processing elements 192 include a control circuit, registers, and/or counters responsive to control signals received from other system components. For one embodiment, the fabric 120 includes one or more circuits, which employ a clock signal 162 to pace their operations. For this embodiment, the clock signal 162 used to pace the operations of the fabric 120 is produced by an electronic oscillator 172. The clock signal 162 produced by the oscillator 172 can be generated as a consistent number of pulses over a period of time (e.g., every second, etc.) in the form of a waveform (e.g., a sinusoidal waveform, a non-sinusoidal waveform, etc.). The frequency of the clock signal 162 determines the rate at which the fabric 120 configures itself to interconnect two or more system components and, consequently, the higher the frequency of the clock signal 162, the more rapidly the fabric 120 may be reconfigured.

For one embodiment, the system 100 includes a performance control logic/module 195 for managing at least one of the CPU 105, the GPU 110, the microcode engine 115, the communication fabric 120, the memory controller 130, or the peripheral control circuit 135. The performance control logic/module 195 can be processing logic that comprises hardware (e.g., circuitry, dedicated logic, etc.), software (such as is run on a general-purpose computer system or a dedicated machine), or a combination of both.

The performance control logic/module 195 can assist with intelligently applying DVFS to at least one of the CPU 105, the GPU 110, the microcode engine 115, the communication fabric 120, the memory controller 130, or the peripheral control circuit 135 of the processing system 100 based on constraints affecting at least two of the CPU 105, the GPU 110, the microcode engine 115, the communication fabric 120, the memory controller 130, or the peripheral control circuit 135 of the processing system 100.

The following description is provided in connection with the GPU 110; however, the following description is applicable to at least one of the CPU 105, the GPU 110, the microcode engine 115, the communication fabric 120, the memory controller 130, or the peripheral control circuit 135 of the processing system 100.

For one embodiment, managing the GPU 110 begins when the performance control logic/module 195 monitors the GPU 110 to obtain information associated with the GPU 110. The monitored information associated with the GPU 110 can include information about resource usage by the GPU 110 (e.g., the bandwidth of the GPU 110, etc.), a performance of the GPU 110 (e.g., the workload of the GPU 110, etc.), and/or the power consumption levels of the GPU 110. For one embodiment, the obtained information includes at least one of a workload of the GPU 110 (e.g., a number of pending operations or transactions to be performed by the processing elements 191 of the GPU 110, etc.) or a bandwidth of the GPU 110 (e.g., a rate of data transfer associated with the GPU 110 that is measured over a period of time, etc.). The bandwidth of the GPU 110 can, for example, be measured in bits per second or bytes per second.

For one embodiment, the performance control logic/module 195 determines that an operational performance of the GPU 110 should be adjusted (e.g., increase the throughput of GPU 110, decrease the throughput of GPU 110, etc.) based on the information collected from the GPU 110. As a first example, the performance control logic/module 195 makes this determination by ascertaining that the workload of the GPU 110 has exceeded a threshold or that the bandwidth of the GPU 110 has exceeded a threshold. As a second example, the performance control logic/module 195 makes this determination by determining that the workload of the GPU 110 has not exceeded a threshold or that the bandwidth of the GPU 110 has not exceeded a threshold. For one embodiment, the threshold associated with the workload of the GPU 110 can be at least one of a predetermined threshold, a threshold that depends on one or more predefined conditions, or a threshold that is dynamically determined. Furthermore, the threshold associated with the bandwidth of the GPU 110 can be at least one of a predetermined threshold, a threshold that depends on one or more predefined conditions, or a threshold that is dynamically determined.

When at least one of the threshold associated with the workload of the GPU 110 or the threshold associated with the bandwidth of the GPU 110 is a predetermined threshold or a threshold that depends on one or more predefined conditions, such a threshold can be determined based on measurements obtained during a sampling phase or testing period of the GPU 110. For example, the sampling phase can include the following: (i) providing known input signals to the GPU 110 based on knowledge of one or more internal states of the GPU 110 and/or a history of one or more processing operations performed by the GPU 110 on these known input signals; and (ii) measuring the actual operations of the GPU 110 during the sampling phase. The measurements that are obtained during the sampling phase may be used to determine relationships between the threshold associated with the workload of the GPU 110 and the threshold associated with the bandwidth of the GPU 110. The measurements performed during the sampling phase can include hysteresis, which refers to the time-based dependence of an output that results from operations of the GPU 110 on present and past inputs provided to the GPU 110. The hysteresis that is observed during the sampling phase can be rate-dependent hysteresis or rate-independent hysteresis. For some embodiments, at least one of the threshold associated with the workload of the GPU 110 or the threshold associated with the bandwidth of the GPU 110 can be an average of the obtained measurements during the sampling period or a peak value of the obtained measurements during the sampling period.

When at least one of the threshold associated with the workload of the GPU 110 or the threshold associated with the bandwidth of the GPU 110 is a dynamically determined threshold, such a threshold can be determined based on, for example, a combination of the workloads of multiple components of the system 100 and/or the bandwidths of multiple components of the system 100. For example, the dynamically determined threshold can be determined based on at least one of a total workload associated with the entire system 100 (as opposed to its constituent components) or a total bandwidth associated with the entire system 100 (as opposed to its constituent components).

For one embodiment, the performance control logic/module 195 determines that an operational performance of the GPU 110 should be adjusted based on the following: (i) a relationship between the workload of the GPU 110 and a first threshold that is a predetermined threshold, a threshold depends on one or more predefined conditions, or a threshold that is dynamically determined; and (ii) a relationship between the bandwidth of the GPU 110 and a second threshold that is a predetermined threshold, a threshold depends on one or more predefined conditions, or a threshold that is dynamically determined. For one example, the first threshold associated with the workload of the GPU 110 can be set to a percentage value, which indicates that the workload of the GPU 110 is within a specified percentage of an allowable workload associated with the GPU 110 or a maximum workload associated with the GPU 110. For this example, the second threshold associated with the bandwidth of the GPU 110 can be set to a percentage value, which indicates that the bandwidth of the GPU 110 is within a specified percentage of the maximum bandwidth associated with the GPU 110. Furthermore, and for this example, the performance control logic/module 195 determines that an operational performance of the GPU 110 should be adjusted (e.g., a frequency of a clock signal associated the GPU 110 should be increased or decreased, etc.) when the actual workload of the GPU 110 is within the first threshold and when the actual bandwidth associated with the GPU 110 remains below the second threshold. In other words, the performance control logic/module 195 will determine that the clock signal frequency of the GPU 110 needs to be adjusted when the GPU 110 is busy, and the bandwidth of the GPU 110 is below a specified threshold.

It is to be appreciated that several variations and combinations of the thresholds described above can be used by the performance control logic/module 195 to determine that an operational performance of a component of the system 100 (e.g., the GPU 110, etc.) should be adjusted. For example, the performance control logic/module 195 can determine that the clock signal frequency of the GPU 110 needs to be adjusted when the GPU 110 is not busy (e.g., its workload is below a maximum workload or below an allowable workload, etc.), and a bandwidth associated with the GPU 110 is below a specified threshold (e.g., a rate of data being transferred into or out of the GPU 110 is below a maximum bandwidth associated with the GPU 110, etc.).

For one embodiment, the performance control logic/module 195 also monitors information associated with at least one other component of the system 100 that is not the GPU 110 to obtain information about the monitored component(s). The at least one other component of the system 100 may include at least one of the CPU 105, the microcode engine 115, the communication fabric 120, the memory controller 130, or the peripheral control circuit 135 of the processing system 100. For the sake of brevity, these components will be collectively referred to herein as “the other component(s) of the system 100.”

The performance control logic/module 195 can perform the monitoring of the other component(s) of the system 100 in response to the performance control logic/module 195 determining that the operational performance of the GPU 110 should be adjusted. Alternatively, the performance control logic/module 195 can perform the monitoring of the other component(s) of the system 100 before the performance control logic/module 195 determines that the operational performance of the GPU 110 should be adjusted. For example, the performance control logic/module 195 can perform the monitoring of the other component(s) of the system 100 while the performance control logic/module 195 monitors the GPU 110 to obtain information associated with the GPU 110.

The monitored information associated with the other component(s) of the system 100 can include information about resource usage by the other component(s) of the system 100 (e.g., the bandwidth of the other component(s) of the system 100, etc.), a performance of the other component(s) of the system 100 (e.g., the workload of the other component(s) of the system 100, etc.), and/or the power consumption by the other component(s) of the system 100. For one embodiment, the obtained information includes at least one of a workload of the other component(s) of the system 100 (e.g., a number of pending operations or transactions to be performed by the processing elements 190 of the CPU 105, etc.) or a bandwidth of the other component(s) of the system 100 (e.g., a rate of data transfer associated with the fabric 120 that is measured over a period of time, etc.). The bandwidth of the other component(s) of the system 100 can, for example, be measured in bits per second or bytes per second.

For one embodiment, the performance control logic/module 195 evaluates the obtained information of the other component(s) of the system 100 to determine that an operational performance of the other component(s) should be adjusted to satisfy the determined need to adjust the operational performance of GPU 110. As a first example, the performance control logic/module 195 evaluates this information and makes the determination by ascertaining that the workload of the other component(s) of the system 100 has not exceeded a threshold or that the bandwidth of the other component(s) of the system 100 has not exceeded a threshold. As a second example, the performance control logic/module 195 evaluates this information and makes the determination by ascertaining that the workload of the other component(s) of the system 100 has exceeded a threshold or that the bandwidth of the other component(s) of the system 100 has exceeded a threshold.

For one embodiment, the threshold associated with the workload of the other component(s) of the system 100 can be at least one of a predetermined threshold, a threshold that depends on one or more predefined conditions, or a threshold that is dynamically determined. Furthermore, the threshold associated with the bandwidth of the other component(s) of the system 100 can be at least one of a predetermined threshold, a threshold that depends on one or more predefined conditions, or a threshold that is dynamically determined. When at least one of the threshold associated with the workload of the other component(s) of the system 100 or the threshold associated with the bandwidth of the other component(s) of the system 100 is a predetermined threshold or a threshold that depends on one or more predefined conditions, such a threshold can be determined based on measurements obtained during a sampling phase or testing period of the other component(s) of the system 100. For example, the sampling phase can include the following: (i) providing known input signals to the other component(s) of the system 100 based on knowledge of one or more internal states of the other component(s) of the system 100 and/or a history of one or more processing operations performed by the other component(s) of the system 100 on these known input signals; and (ii) measuring the actual operations of the other component(s) of the system 100 during the sampling phase. The measurements that are obtained during the sampling phase may be used to determine relationships between the threshold associated with the workload of the other component(s) of the system 100 and the threshold associated with the bandwidth of the other component(s) of the system 100. The measurements performed during the sampling phase can include hysteresis, which refers to the time-based dependence of an output that results from operations of the other component(s) of the system 100 on present and past inputs provided to the other component(s) of the system 100. The hysteresis that is observed during the sampling phase can be rate-dependent hysteresis or rate-independent hysteresis. For some embodiments, at least one of the threshold associated with the workload of the other component(s) of the system 100 or the threshold associated with the bandwidth of the other component(s) of the system 100 can be an average of the obtained measurements during the sampling period or a peak value of the obtained measurements during the sampling period.

When at least one of the threshold associated with the workload of the other component(s) of the system 100 or the threshold associated with the bandwidth of the other component(s) of the system 100 is a dynamically determined threshold, such a threshold can be determined based on, for example, a combination of the workloads of multiple components of the system 100 and/or the bandwidths of multiple components of the system 100. For example, the dynamically determined threshold can be determined based on at least one of a total workload associated with the entire system 100 (as opposed to its constituent components) or a total bandwidth associated with the entire system 100 (as opposed to its constituent components).

For one embodiment, the performance control logic/module 195 determines that an operational performance of the other component(s) of the system 100 should be adjusted to satisfy the determined need associated with the GPU 110 based on the following: (i) a relationship between the workload of the other component(s) of the system 100 and a first threshold that is a predetermined threshold, a threshold depends on one or more predefined conditions, or a threshold that is dynamically determined; and (ii) a relationship between the bandwidth of the other component(s) of the system 100 and a second threshold that is a predetermined threshold, a threshold depends on one or more predefined conditions, or a threshold that is dynamically determined. For one example, the first threshold associated with the workload of the other component(s) of the system 100 can be set to a percentage value, which indicates that the workload of the other component(s) of the system 100 is within a specified percentage of an allowable workload associated with the other component(s) of the system 100 or a maximum workload associated with the other component(s) of the system 100. For this example, the second threshold associated with the bandwidth of the other component(s) of the system 100 can be set to a percentage value, which indicates that the bandwidth of the other component(s) of the system 100 is within a specified percentage of the maximum bandwidth associated with the other component(s) of the system 100. Furthermore, and for this example, the performance control logic/module 195 determines that the operational performance of the other component(s) of the system 100 should be adjusted (e.g., a frequency of a clock signal associated the other component(s) of the system 100 should be increased or decreased, etc.) to satisfy the determined need associated with the GPU 110 when the actual workload of the other component(s) of the system 100 is within the first threshold and when the actual bandwidth associated with the other component(s) of the system 100 remains below the second threshold. In other words, the performance control logic/module 195 will determine that the clock signal frequency of the other component(s) of the system 100 needs to be adjusted to satisfy the determined need associated with the GPU 110 when the other component(s) of the system 100 is busy, and the bandwidth of the other component(s) of the system 100 is below a specified threshold.

It is to be appreciated that several variations and combinations of the thresholds described above can be used by the performance control logic/module 195 to determine that an operational performance of the other component(s) of the system 100 (e.g., the CPU 105, the fabric 120, the memory controller 130, the peripheral control circuit 135, the microcode engine 115, etc.) should be adjusted to satisfy the determined need associated with the first component of the system 100 (e.g., the GPU 110, etc.). For example, the performance control logic/module 195 can determine that the clock signal frequencies associated with the fabric 120 and the memory controller 130 should be adjusted when each of the fabric 120 and the memory controller 130 is not busy (e.g., its workload is below a maximum workload, its workload is below an allowable workload, etc.), and a bandwidth associated with each of the fabric 120 and the memory controller 130 is below a specified threshold (e.g., a rate of data being transferred into or out of each of the fabric 120 and the memory controller 130 is below a maximum bandwidth, etc.).

Determining, by the performance control logic/module 195, that an operational performance of the other component(s) of the systems should be adjusted to satisfy the determined need to adjust the operational performance of GPU 110 can result in adjusting a frequency of the clock signal 161 that affects the operational performance of the GPU 110 and/or one or more clock signals that affect the operational performance of the other component(s) of the systems. The performance control logic/module 195 can adjust the clock signals by directing the oscillators 170, 171, 172, 173, 174, or 175 to change the respective operational frequencies, which in turn results in increasing or decreasing the respective frequencies of the clock signals of the GPU 110 and the other component(s) of the system 100. The clock signal(s) of the other component(s) of the system 100 include at least one of the clock signal 160 affecting the CPU 105, the clock signal 162 affecting the fabric 120, the clock signal 163 affecting the memory controller 130, the clock signal 164 affecting the peripheral control circuit 135, or the clock signal 165 affecting the microcode engine 115.

With regard again to FIG. 1, the performance control logic/module 195 can manage at least one component of the system 100 when the system 100 is performing a task. As a first example, and for one embodiment, the performance control logic/module 195 can manage at least one component of the system 100 during performance of a task 185 that includes writing of data from the GPU 110 to the system memory 140. For this embodiment, the performance control logic/module 195 monitors each of the components of system 100 involved in performing the task 185 to obtain information about each of the monitored components. As shown in FIG. 1, these components include the microcode engine 115, the communication fabric 120, and the memory controller 130. In illustrated embodiment of FIG. 1, the performance control logic/module 195 does not monitor the local memory 125 or the system memory 140; however, other embodiments are not so limited. For example, the performance control logic/module 195 can monitor the local memory 125 and/or the system memory 140 in addition to the other components of the system 100 involved in performing the task 185.

Still with regard to FIG. 1, the performance control logic/module 195 determines that the operational performance of the GPU 110 should be adjusted based on the obtained information associated with the GPU 110. For example, the decision to adjust the operational performance of the GPU 110 may be triggered by the performance control logic/module 195 determining that a workload associated with the GPU 110 has or has not exceeded a threshold. The threshold associated with the workload of the GPU 110 can include a number of pending transactions to be performed by the GPU 110, a number of current transactions that are currently being performed by the GPU 110, and/or a number of past transactions that have already been performed by the GPU 110. For another example, the decision to adjust the operational performance of the GPU 110 is triggered by the performance control logic/module 195 determining that a bandwidth associated with a performance of operations by the GPU 110 has or has not exceeded a threshold. These examples can be combined.

Based on the determination that the operational performance of the GPU 110 is to be adjusted, the performance control logic/module 195 evaluates the obtained information that is associated with at least one of the components involved in performing the task 185—that is, at least one of the microcode engine 115, the communication fabric 120, or the memory controller 130. This evaluation can include determining that a workload associated with at least one of the microcode engine 115, the communication fabric 120, or the memory controller 130 has or has not exceeded a threshold. The threshold associated with the workload of at least one of the microcode engine 115, the communication fabric 120, or the memory controller 130 can include at least one of the following: (i) a number of pending transactions to be performed by at least one of the microcode engine 115, the communication fabric 120, or the memory controller 130; (ii) a number of current transactions that are currently being performed by at least one of the microcode engine 115, the communication fabric 120, or the memory controller 130; or (iii) a number of past transactions that have already been performed by at least one of the microcode engine 115, the communication fabric 120, or the memory controller 130. For another example, this evaluation can include determining that a bandwidth associated with a performance of operations by at least one of the microcode engine 115, the communication fabric 120, or the memory controller 130 has or has not exceeded a threshold. These examples can be combined.

Next, the performance control logic/module 195 directs the oscillator 171 (associated with the GPU 110) to adjust the frequency of the clock signal 161, which in turn adjusts the operational performance of the GPU 110. In addition, the performance control logic/module 195 directs at least one of the oscillator 175 (associated with the microcode engine 115), the oscillator 172 (associated with the fabric 120), or the oscillator 173 (associated with the memory controller 130) to adjust the respective frequencies of the clock signals 165, 162, or 163. In this way, the performance control logic/module 195 manages at least two components of the system 100 that are involved in performing the task 185 so as to assist with intelligently improving performance and/or power consumption by the system 100.

As explained above, adjusting the operational performance of only one component of a system (e.g., GPU 110 of the system 100) does not necessarily improve the performance or power consumption of the system. This is because the operation of this single component of the system (e.g., GPU 110 of the system 100, etc.) may be dependent on other components of the system (e.g., the microcode engine 115, the communication fabric 120, the memory controller 130, etc.). For example, even if a workload of the GPU 110 (e.g., a number of pending operations to be performed by the GPU 110, etc.) exceeds a threshold, increasing the operational performance of the GPU may not improve the performance or power consumption of the system 100 if a workload and/or a bandwidth associated with the fabric 120 and a workload and/or a bandwidth associated with the memory controller 130 are suboptimal. Consequently, adjusting the operational performances of the fabric 120 and the memory controller 130, together with the operational performance of the GPU 110, can assist with providing an improved technique for improving the performance or power consumption of the system. One way that the performance control logic/module 195 can adjust the frequency of the clock signal associated with the first component of the system 100 (e.g., the GPU 110, etc.) and the one or more frequencies of the clock signal(s) associated with the other component(s) of the system 100 (e.g., the fabric 120, the memory controller 130, etc.) includes the performance control logic/module 195 determining and making the lowest frequency adjustment that will consume the least amount of power for each component whose operational performance is to be adjusted. For example, the performance control logic/module 195 may be capable of adjusting the frequency of the clock signal associated with the GPU 110 to a first frequency or to a second frequency, where operating the GPU 110 at the second frequency would require a higher amount of power consumption by the GPU 110 than operating the GPU 110 at the first frequency. In this situation, the performance control logic/module 195 would adjust the frequency of the GPU 110 to the first frequency (and not the second frequency), because the first frequency improves the functioning of the GPU 110 and has the lower power requirement of the two frequencies. Furthermore, and for this example, the performance control logic/module 195 may be capable of adjusting the one or more frequencies of the clock signal(s) associated with the other component(s) of the system 100 (e.g., the fabric 120, the memory controller 130, etc.) to a first frequency or a second frequency, where operating the other component(s) of the system 100 at the second frequency would require a higher amount of power consumption by the other component(s) of the system 100 than operating the other component(s) of the system 100 at the first frequency. In this situation, the performance control logic/module 195 would adjust the frequency of the other component(s) of the system 100 to the first frequency (and not the second frequency), because the first frequency improves the functioning of the other component(s) of the system 100 and has the lower power requirement of the two frequencies. In this way, the performance control logic/module 195 can adjust frequencies that affect the operations of multiple components of the system 100 in a way that brings about an improved performance of these components in view of the lowest possible amount of power consumption by those components.

Referring again to FIG. 1, it is to be appreciated that the monitoring and determination operations associated with the performance of the task 185 can be performed serially. For example, the monitoring and determination operations can be performed only with respect to a single component of the system 100 (e.g., the GPU 110) before the monitoring and determination operations are performed with respect to the other component(s) of the system 100. It is also to be appreciated that the monitoring and determination operations associated with the performance of the task 185 can be performed simultaneously. For example, the monitoring and determination operations can be performed with respect to a first component of the system 100 (e.g., the GPU 110) while the monitoring and determination operations are performed with respect to the other component(s) of the system 100. One or more of the components of the system 100 can be part of a clock domain such that each component in the clock domain shares a common clock signal. For example, the GPU 110 and the CPU 105 can be part of the same clock domain such that these two components are controlled using a common clock signal.

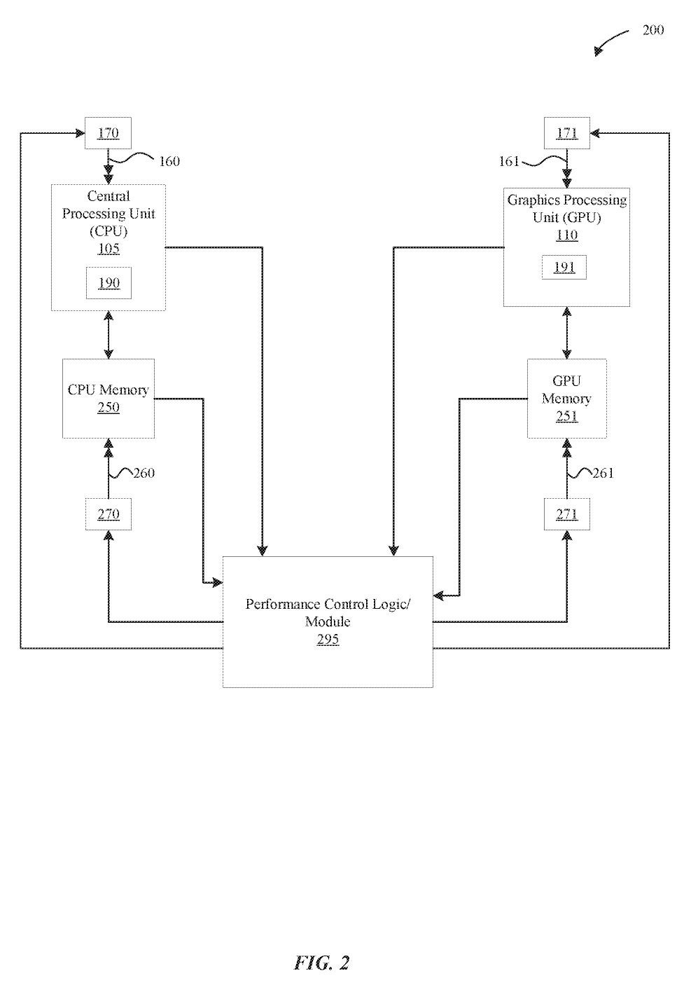

Referring now to FIG. 2, which is a block diagram of another processing system 200 including electronic components that can be managed in accordance with one embodiment. The system 200 includes a CPU 105, a GPU 110, a CPU memory 250, a GPU memory 251, oscillators 170, 171, 270, and 271, and performance control logic/module 295. For the sake of brevity, those components discussed above in connection with FIG. 1 will not be described in connection with FIG. 2. It is to be appreciated that these previously described components are similar to or the same as the components illustrated in FIG. 2.

For one embodiment of the system 200, the CPU 105 is communicatively coupled to the CPU memory 250 while the GPU 110 is communicatively coupled to the GPU memory 251. The CPU memory 250 can be system memory, which provides data storage and retrieval services for the processing operations performed by the CPU 105. The GPU memory 251 can be frame buffer memory, which provides data storage and retrieval services for the processing operations performed by the GPU 110 and/or an associated display unit (not shown). Each of the CPU memory 250 and the GPU memory 251 can be any known memory. For example, dynamic random access memory (DRAM), synchronous dynamic random access memory (SDRAM), non-volatile memory devices (e.g., flash memory devices, phase change memory devices, resistance memory devices and the like), etc. Furthermore, each of the CPU memory 250 and the GPU memory 251 may be a cache—that is, CPU memory 250 and the GPU memory 251 are smaller portions of a main memory of system 200 (not shown) that require less time to access than the main memory and often are privately used by CPU 105 and the GPU 110, respectively.

As shown in FIG. 2, the CPU memory 250 and the GPU memory 251 operate based on clock signals 260 and 261, respectively. The clock signals 260 and 261 are produced by the oscillators 270 and 271, respectively. These clock signals 260 and 261 may be based on a system clock signal (not shown) that enables the CPU memory 250 and the GPU memory 251 to provide data in synchronization with rising and falling edges of the system clock signal. Alternatively, the clock signal 260 may be based on the clock signal 160 provided to the CPU 105 to enable the CPU memory 250 to provide data in synchronization with rising and falling edges of the clock signal 160. Furthermore, the clock signal 261 may be based on the clock signal 161 provided to the GPU 110 to enable the GPU memory 251 to provide data in synchronization with rising and falling edges of the clock signal 161.

The performance control logic/module 295 is similar to or the same as the performance control logic/module 195 described above in connection with FIG. 1. For one embodiment, the performance control logic/module 295 monitors at least one of the components of system 200 (e.g., the GPU memory 251) to obtain information about the monitored component(s) of the system 200. For one embodiment, the performance control logic/module 295 determines that an operational performance of a first component of system 200 (e.g., the GPU memory 251) needs to be adjusted based on the obtained data. This determination can be performed in accord with the description provided above in connection with FIG. 1. Furthermore, and for one embodiment, the performance control logic/module 295 monitors at least one of the other components of the system 200 (e.g., the CPU 105, the GPU 110, or the CPU memory 250, etc.) to obtain information about the other component(s) of the system 200.

For another embodiment, the performance control logic/module 295 monitors more than one component of the system 200 (e.g., at least two of the CPU 105, the GPU 110, the GPU memory 251, or the CPU memory 250) to obtain information about the monitored component(s) of the system 200. For this embodiment, the monitoring operation can be performed before the logic/module 295 determines that an operational performance of a first component of system 200 (e.g., the GPU memory 251) should be adjusted based on the obtained data.

For one embodiment, the performance control logic/module 295 evaluates the obtained information associated with the other component(s) of the system 200 (e.g., the CPU 105, the GPU 110, and/or the CPU memory 250) to determine that an operational performance of another component(s) of system 200 (e.g., the GPU 110, etc.) needs to be adjusted to satisfy the need to adjust the operational performance of the first component of system 200 (e.g., the GPU memory 251). For example, after the performance control logic/module 295 determines that a number of pending transactions to be performed by the first component of system 200 (e.g., the GPU memory 251) has or has not exceeded a threshold and that a bandwidth associated with the first component of system 200 (e.g., the GPU memory 251) has or has not exceeded another threshold, the performance control logic/module 295 evaluates another component of the system 200 (e.g., the GPU 110) to determine that an adjustment to the operational performance of this other component of the system 200 (e.g., the GPU 110) will improve performance of the first component of system 200 (e.g., the GPU memory 251). This evaluation can include determining whether a number of pending transactions to be performed by the other component of the system 200 (e.g., the GPU 110) has or has not exceeded a threshold and that a bandwidth associated with the other component of the system 200 (e.g., the GPU 110) has or has not exceeded a threshold.

For one embodiment, the performance control logic/module 295 directs the oscillator associated with the clock signal of the first component of the system 200 (e.g., oscillator 271 associated with the GPU memory 251) to adjust the frequency of the clock signal associated with the first component of the system 200 (e.g., clock signal 261). Furthermore, the performance control logic/module 295 directs the oscillator associated with the clock signal of the other component of the system 200 (e.g., oscillator 171 associated with the GPU 110) to adjust the frequency of the clock signal associated with the other component of the system 200 (e.g., clock signal 161). In this way, the performance control logic/module 295 can manage the performance and/or power consumption of the system 200. One or more of the components of the system 100 can be part of a clock domain such that each component in the clock domain shares a common clock signal. For example, the GPU 110 and the CPU 105 can be part of the same domain such that these two components are controlled using a common clock signal. Thus, an adjustment to the frequency of the GPU 110 may affect the frequency of the CPU 105.

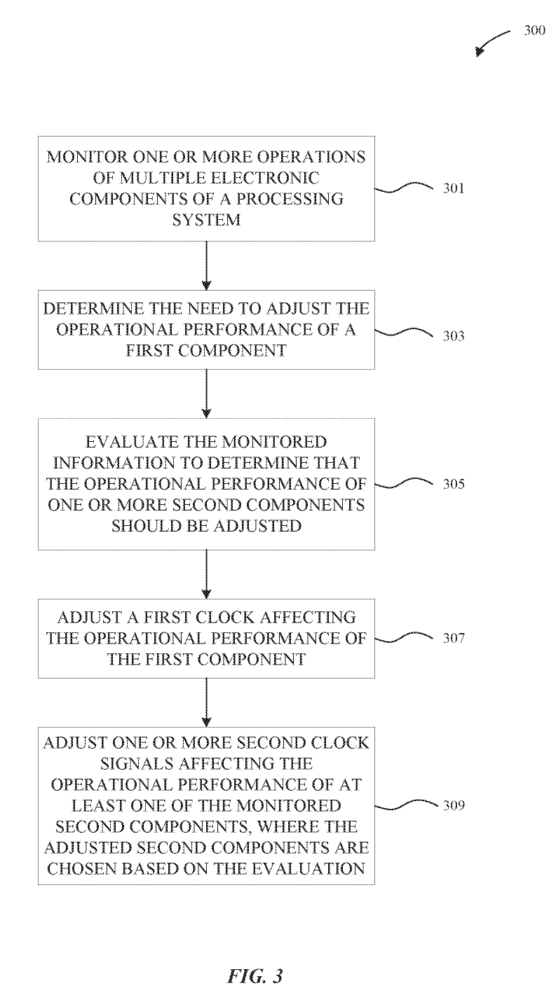

FIG. 3 is a flowchart representing a process 300 of managing electronic components of a processing system in accordance with one embodiment. Process 300 can be performed by a performance control logic/module (e.g., the performance control logic/modules 195 and 296 described above in connection with FIGS. 1 and 2, respectively).

Process 300 begins at block 301 where multiple components of an electronic system are monitored to acquire information about these components. These components can include one or more processors, a communication fabric, memory, a peripheral control circuit, and/or any other electronic component that operates based on clock signals. For one embodiment, the obtained information can be based on ALU(s), register(s), counter(s), driver(s), and/or other processing elements associated with components of the processing system. For one embodiment, the monitoring of the components to obtain information is performed in accord with the description provided above in connection with FIG. 1 or 2.

Process 300 proceeds to block 303 where a need to adjust an operational performance of a first component of the processing system is determined. The need can be determined based on the obtained information that was collected in block 301. For one embodiment, the need to adjust an operational performance of a first component of the processing system is determined in accord with the description provided above in connection with at least one of FIG. 1 or 2. At block 305 of process 300, an evaluation of the monitored information associated with one or more second components of the system is performed. This evaluation is performed to determine that an operational performance of one or more of these second components should be adjusted in order to satisfy the need to adjust the operational performance of a first component of the processing system. For one embodiment, this evaluation is performed in accord with the description provided above in connection with FIG. 1 or 2.

At block 307 of process 300, a frequency of a clock signal affecting the operational performance of the first component of the system is adjusted. Furthermore, at block 309 of process 300 one or more frequencies of one or more clock signals that affect the operational performance(s) of the one or more second components of the system are adjusted. The adjustments in blocks 307 and 309 can be performed in response to the evaluation performed at block 305.

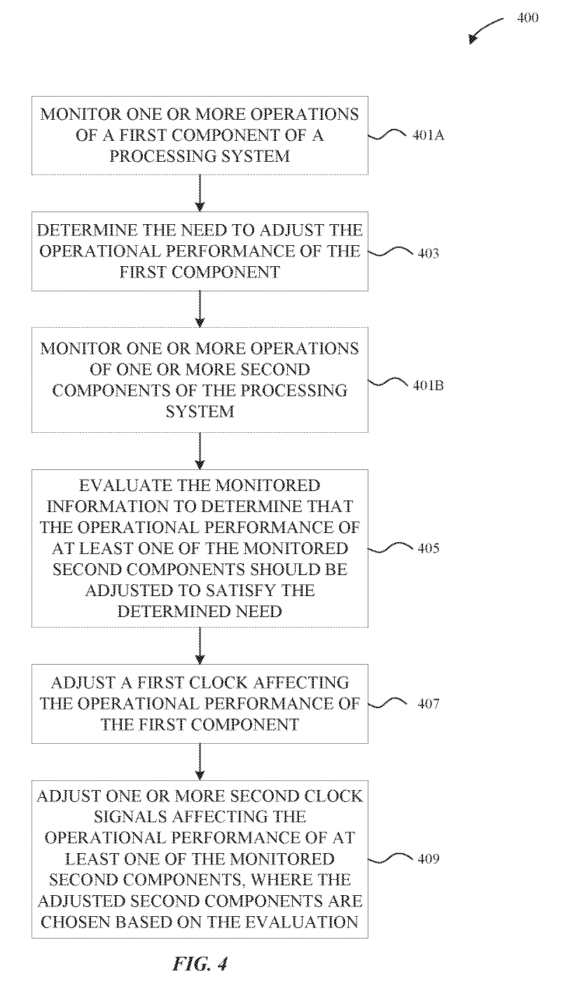

FIG. 4 is a flowchart representing another embodiment of a process 400 of managing electronic components of a processing system. Process 400 can be performed by a performance control logic/module (e.g., the performance control logic/modules 195 and 296 described above in connection with FIGS. 1 and 2, respectively).

Process 400 begins at block 401A, where a first component of a processing system is monitored to acquire information about the first component. For example, a GPU of a processing system can be monitored to collect information about the GPU's performance, resource usage, and/or power consumption levels. The collected information associated with the first component can include information indicative of a workload of the first component and/or a bandwidth of the first component. For one embodiment, the monitoring of the first component of the processing system is performed in accord with the description provided above in connection with at least one of FIG. 1 or 2. Process 400 proceeds to block 403 where a determination is made that an operational performance of the first component of the processing system should be adjusted to increase or decrease performance or power consumption by the first component. The determination in block 403 is performed based on the information acquired in block 401A. For one embodiment, the determination that an operational performance of the first component needs to be adjusted is performed in accord with the description provided in connection with FIG. 1 or 2.

At block 401B, one or more other (i.e., second) components of the processing system are monitored to acquire information about these other component(s). For example, in response to determining that an operational performance of GPU of a system needs to adjusted, then information associated with other components of the system can be acquired. For one embodiment, the obtained information can be based on ALU(s), register(s), counter(s), driver(s), and/or other processing elements associated with the other component(s) of the processing system. For example, the other component(s) of a processing system can be monitored to collect information about their performance, resource usage, and/or power consumption levels. For each of the other component(s), the collected information associated with that component can include information indicative of a workload of that component and/or a bandwidth of that component. For one embodiment, the monitoring of the other component(s) to obtain information is performed in accord with the description provided above in connection with at least one of FIG. 1 or 2.

Process 400 proceeds to blocks 405, 407 and 409 after block 401B. Blocks 405, 407, and 409 of process 400 are similar to or the same as blocks 305, 307, and 309 of process 300, respectively. Blocks 305, 307, and 309 are described above in connection with FIG. 3. So, these blocks will not described again for the sake of brevity.

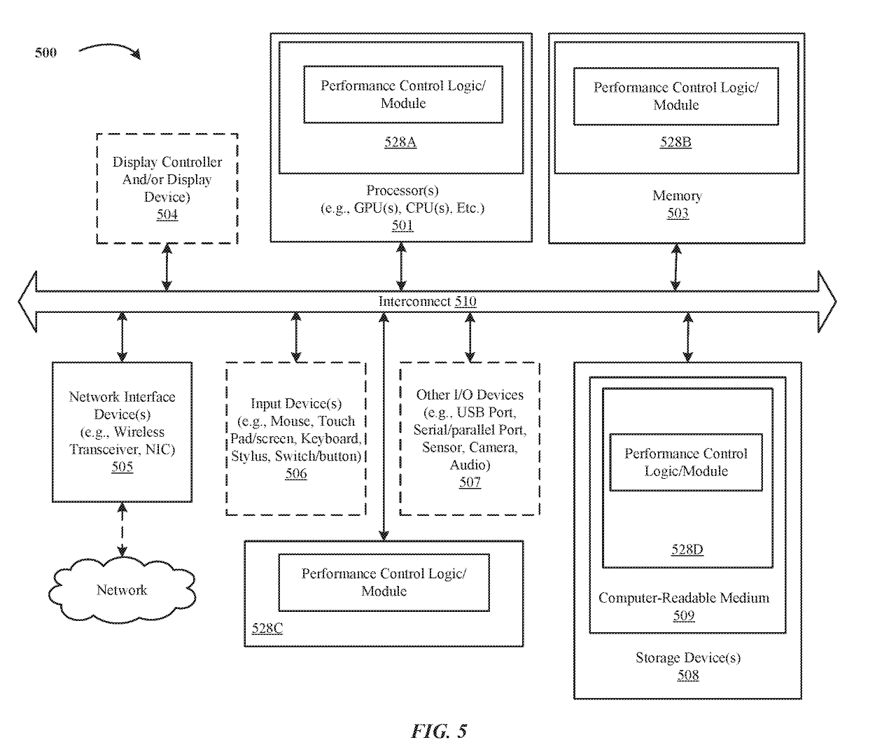

FIG. 5 is a block diagram illustrating an example of a data processing system 500 that may be used with one embodiment. For example, the system 500 may represent any of data processing systems described above performing any of the processes or methods described above in connection with at least one of FIG. 1, 2, 3, or 4.

System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. Nevertheless, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute at least one set of instructions to perform any of the methodologies discussed herein.

For one embodiment, system 500 includes processor 501, memory 503, and devices 505-508 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), an Application-specific instruction set processor (ASIP), a cellular or baseband processor, a field programmable gate array (FPGA), a digital signal processor (DSP), a physics processing unit (PPU), an image processor, an audio processor, a network processor, a graphics processor, a graphics processing unit (GPU), a network processor, a communications processor, a cryptographic processor, a co-processor, an embedded processor, a floating-point unit (FPU), or any other type of logic capable of processing instructions. A

Processor 501, which may be a low power multi-core processor socket such as an ultra-low voltage processor, may act as a main processing unit and central hub for communication with the various components of the system. Such processor can be implemented as a system-on-chip (SoC) IC. Performance control logic/module 528A may reside, completely or at least partially, within processor 501. Furthermore, the processor 501 is configured to execute instructions for performing the operations and methodologies discussed herein. System 500 may further include a graphics interface that communicates with optional graphics subsystem 504, which may include a display controller, a graphics processing unit (GPU), and/or a display device. For one embodiment, the processor 501 includes logic/module 528A, which is enabled processor 501 to perform any of the processes or methods described above in connection with at least one of FIG. 1, 2, 3, or 4.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501 or any other device. For example, executable code and/or data of a variety of operating systems, device drivers, firmware (e.g., input output basic system or BIOS), and/or applications can be loaded in memory 503 and executed by processor 501. An operating system can be any kind of operating system. Performance control logic/module 528D may also reside, completely or at least partially, within memory 503. For one embodiment, the memory 503 includes performance control logic/module 528B, which are instructions. When the instructions represented by performance control logic/module 528B are executed by the processor 501, these instructions 528B cause the processor 501 to perform any of the processes or methods described above in connection with at least one of FIG. 1, 2, 3, or 4.

System 500 may further include I/O devices such as devices 505-508, including network interface device(s) 505, optional input device(s) 506, and other optional I/O device(s) 507. Network interface device 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with display device 504), a pointer device such as a stylus, and/or a keyboard (e.g., physical keyboard or a virtual keyboard displayed as part of a touch sensitive screen). For example, input device 506 may include a touch screen controller coupled to a touch screen. The touch screen and touch screen controller can, for example, detect contact and movement or a break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

I/O devices 507 may include an audio device. An audio device may include a speaker and/or a microphone to facilitate voice-enabled functions, such as voice recognition, voice replication, digital recording, and/or telephony functions. Other I/O devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. For various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. In addition, a flash device may be coupled to processor 501, e.g., via a serial peripheral interface (SPI). This flash device may provide for non-volatile storage of system software, including a basic input/output software (BIOS) and other firmware.

Storage device 508 may include computer-accessible storage medium 509 (also known as a machine-readable storage medium or a computer-readable medium) on which is stored one or more sets of instructions or software (e.g., performance control logic/module 528D) embodying any one or more of the methodologies or functions described herein. For one embodiment, the Storage device 508 includes performance control logic/module 528D, which are instructions. When the instructions represented by performance control logic/module 528D are executed by the processor 501, these instructions 528D cause the processor 501 to perform any of the processes or methods described above in connection with at least one of FIG. 1, 2, 3, or 4. At least one of the performance control logic/modules 528A, 528B, 528C, or 528D may further be transmitted or received over a network via network interface device 1305.

Computer-readable storage medium 509 may also be used to store the some software functionalities of the performance control logic/module 528D described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Note that while system 500 is illustrated with various components of a data processing system, it is not intended to represent any particular architecture or manner of interconnecting the components; as such, details are not germane to the embodiments described herein. It will also be appreciated that network computers, handheld computers, mobile phones, servers, and/or other data processing systems, which have fewer components or perhaps more components, may also be used with the embodiments described herein.

Description of at least one of the embodiments set forth herein is made with reference to figures. However, certain embodiments may be practiced without one or more of these specific details, or in combination with other known methods and configurations. In the following description, numerous specific details are set forth, such as specific configurations, dimensions and processes, etc., in order to provide a thorough understanding of the embodiments. In other instances, well-known processes and manufacturing techniques have not been described in particular detail in order to not unnecessarily obscure the embodiments. Reference throughout this specification to “one embodiment,” “an embodiment,” “another embodiment,” “other embodiments,” “some embodiments,” and their variations means that a particular feature, structure, configuration, or characteristic described in connection with the embodiment is included in at least one embodiment. Thus, the appearances of the phrase “for one embodiment,” “for an embodiment,” “for another embodiment,” “in other embodiments,” “in some embodiments,” or their variations in various places throughout this specification are not necessarily referring to the same embodiment. Furthermore, the particular features, structures, configurations, or characteristics may be combined in any suitable manner in one or more embodiments.

In the following description and claims, the terms “coupled” and “connected,” along with their derivatives, may be used. It should be understood that these terms are not intended as synonyms for each other. “Coupled” is used to indicate that two or more elements or components, which may or may not be in direct physical or electrical contact with each other, co-operate or interact with each other. “Connected” is used to indicate the establishment of communication between two or more elements or components that are coupled with each other.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

Although the processes or methods are described above in terms of some sequential operations, it should be appreciated that some of the operations described may be performed in a different order. Moreover, some operations may be performed in parallel rather than sequentially. Embodiments described herein are not described with reference to any particular programming language. It will be appreciated that a variety of programming languages may be used to implement the teachings of embodiments of the invention as described herein. In utilizing the various aspects of the embodiments described herein, it would become apparent to one skilled in the art that combinations, modifications, or variations of the above embodiments are possible for managing components of processing system to increase the power and performance of at least one of those components. Thus, it will be evident that various modifications may be made thereto without departing from the broader spirit and scope of at least one of the inventive concepts set forth in the following claims. The specification and drawings are, accordingly, to be regarded in an illustrative sense rather than a restrictive sense.

In the development of any actual implementation of one or more of the inventive concepts set forth in the embodiments described herein (e.g., as a software and/or hardware development project, etc.), numerous decisions must be made to achieve the developers' specific goals (e.g., compliance with system-related constraints and/or business-related constraints). These goals may vary from one implementation to another, and this variation could affect the actual implementation of one or more of the inventive concepts set forth in the embodiments described herein. Furthermore, such development efforts might be complex and time-consuming, but would nevertheless be a routine undertaking for a person having ordinary skill in the art in the design and/or implementation of one or more of the inventive concepts set forth in the embodiments described herein.

As used herein, the phrase “at least one of A, B, or C” includes A alone, B alone, C alone, a combination of A and B, a combination of B and C, a combination of A and C, and a combination of A, B, and C. In other words, the phrase “at least one of A, B, or C” means A, B, C, or any combination thereof such that one or more of a group of elements consisting of A, B and C, and should not be interpreted as requiring at least one of each of the listed elements A, B and C, regardless of whether A, B and C are related as categories or otherwise. Furthermore, the use of the article “a” or “the” in introducing an element should not be interpreted as being exclusive of a plurality of elements. Moreover, the recitation of “A, B and/or C” is equivalent to “at least one of A, B or C,” as explained above.

What is claimed is:

1. A computer-implemented method, comprising:
obtaining information indicative of a workload and a bandwidth associated with each of a plurality of electronic components of a processing system during performance of a task by the processing system,
determining a need to adjust an operational performance of a first component of the processing system based on the obtained information;
evaluating, in response to the determined need, the obtained information to determine that an operational performance of one or more second components of the processing system should be adjusted to satisfy the determined need; and
adjusting, in response to the evaluation, a first clock signal affecting the operational performance of the first component and one or more second clock signals affecting the operational performance of the one or more second components.

2. The method of claim 1, wherein, for each component whose information is obtained, the workload of the component includes a number of pending transactions to be performed by the component and the bandwidth of the component includes a rate of data transfer associated with the component.

3. The method of claim 2, wherein the rate of data transfer associated with component includes at least one of:
a rate of data being transferred into the component, or
a rate of data being transferred out of the component.

4. The method of claim 2, wherein the evaluation includes:
ascertaining that the workload of the first component has exceeded a first threshold or that the bandwidth of the first component has exceeded a second threshold; and
ascertaining that the workload of the one or more second components has not exceeded a third threshold or that the bandwidth of the one or more second components has not exceeded a threshold.

5. The method of claim 2, wherein the evaluation includes:
ascertaining that the workload of the first component has not exceeded a first threshold or that the bandwidth of the first component has not exceeded a second threshold; and
ascertaining that the workload of the one or more second components has exceeded a third threshold or that the bandwidth of the one or more second components has exceeded a fourth threshold.

6. The method of claim 2, wherein the evaluation includes:
ascertaining that the workload of the first component has exceeded a first threshold or that the bandwidth of the first component has exceeded a second threshold; and
ascertaining that the workload of the one or more second components has exceeded a third threshold or that the bandwidth of the one or more second components has exceeded a fourth threshold.

7. The method of claim 2, wherein the evaluation includes:
ascertaining that the workload of the first component has not exceeded a first threshold or that the bandwidth of the first component has not exceeded a second threshold; and
ascertaining that the workload of the one or more second components has not exceeded a third threshold or that the bandwidth of the one or more second components has not exceeded a fourth threshold.

8. A non-transitory computer readable medium comprising instructions, which when executed by one or more processors, cause the one or more processors to:
obtain information indicative of a workload and a bandwidth associated with each of a plurality of electronic components of a processing system during performance of a task by the processing system;
determine a need to adjust an operational performance of a first component of the processing system based on the obtained information;
evaluate, in response to the determined need, the obtained information to determine that an operational performance of one or more second components of the processing system should be adjusted to satisfy the determined need; and
adjust, in response to the evaluation, a first clock signal affecting the operational performance of the first component and one or more second clock signals affecting the operational performance of the one or more second components.

9. The non-transitory computer readable medium of claim 8, wherein, for each component whose information is obtained, the workload of the component includes a number of pending transactions to be performed by the component, and wherein the bandwidth of the component includes a rate of data transfer associated with component.

10. The non-transitory computer readable medium of claim 9, wherein the rate of data transfer associated with component includes at least one of:
a rate of data being transferred into the component, or
a rate of data being transferred out of the component.

11. The non-transitory computer readable medium of claim 9, wherein the instructions that cause the one or more processors to evaluate, in response to the determined need, the obtained information to determine that the operational performance of the one or more second components of the processing system should be adjusted to satisfy the determined need include instructions to cause the one or more processors to:
ascertain that the workload of the first component has exceeded a first threshold or that the bandwidth of the first component has exceeded a second threshold; and
ascertain that the workload of the one or more second components has not exceeded a third threshold or that the bandwidth of the one or more second components has not exceeded a fourth threshold.

12. The non-transitory computer readable medium of claim 9, wherein the instructions that cause the one or more processors to evaluate, in response to the determined need, the obtained information to determine that the operational performance of the one or more second components of the processing system should be adjusted to satisfy the determined need include instructions to cause the one or more processors to:
ascertain that the workload of the first component has not exceeded a first threshold or that the bandwidth of the first component has not exceeded a second threshold; and
ascertaining that the workload of the one or more second components has exceeded a third threshold or that the bandwidth of the one or more second components has exceeded a fourth threshold.

13. The non-transitory computer readable medium of claim 9, wherein the instructions that cause the one or more processors to evaluate, in response to the determined need, the obtained information to determine that the operational performance of the one or more second components of the processing system should be adjusted to satisfy the determined need include instructions to cause the one or more processors to:
ascertain that the workload of the first component has exceeded a first threshold or that the bandwidth of the first component has exceeded a second threshold; and
ascertain that the workload of the one or more second components has exceeded a third threshold or that the bandwidth of the one or more second components has exceeded a fourth threshold.

14. The non-transitory computer readable medium of claim 9, wherein the instructions that cause the one or more processors to evaluate, in response to the determined need, the obtained information to determine that the operational performance of the one or more second components of the processing system should be adjusted to satisfy the determined need include instructions to cause the one or more processors to:
ascertain that the workload of the first component has not exceeded a first threshold or that the bandwidth of the first component has not exceeded a second threshold; and
ascertain that the workload of the one or more second components has not exceeded a third threshold or that the bandwidth of the one or more second components has not exceeded a fourth threshold.

15. A processing system, comprising:
a plurality of electronic components, wherein the components include at least one of:
a graphics processing unit (GPU),
a central processing unit (CPU),
a communication fabric,
a memory controller, or
a peripheral control circuit; and
logic configured to:
obtain information indicative of a workload and a bandwidth associated with each of the plurality of electronic components of the processing system during performance of a task by the processing system;
determine a need to adjust an operational performance of a first component of the processing system based on the obtained information;
evaluate, in response to the determined need, the obtained information to determine that an operational performance of one or more second components of the processing system should be adjusted to satisfy the determined need; and
adjust, in response to the evaluation, a first clock signal affecting the operational performance of the first component and one or more second clock signals affecting the operational performance of the one or more second components.

16. The system of claim 15, wherein the workload of the component includes a number of pending transactions to be performed by the component, and wherein the bandwidth of the component includes a rate of data transfer associated with component.

17. The system of claim 16, wherein the rate of data transfer associated with component includes at least one of:
a rate of data being transferred into the component, or
a rate of data being transferred out of the component.

18. The system of claim 16, wherein the logic configured to perform the evaluation includes logic configured to:
ascertain that the workload of the first component has exceeded a first threshold or that the bandwidth of the first component has exceeded a second threshold; and
ascertain that the workload of the one or more second components has not exceeded a third threshold or that the bandwidth of the one or more second components has not exceeded a fourth threshold.

19. The system of claim 16, wherein the logic configured to perform the evaluation includes logic configured to:
ascertain that the workload of the first component has not exceeded a first threshold or that the bandwidth of the first component has not exceeded a second threshold; and
ascertain that the workload of the one or more second components has exceeded a third threshold or that the bandwidth of the one or more second components has exceeded a fourth threshold.

20. The system of claim 16, wherein the logic configured to perform the evaluation includes logic configured to:
ascertain that the workload of the first component has exceeded a first threshold or that the bandwidth of the first component has exceeded a second threshold; and
ascertain that the workload of the one or more second components has exceeded a third threshold or that the bandwidth of the one or more second components has exceeded a fourth threshold.

21. The system of claim 16, wherein the logic configured to perform the evaluation includes logic configured to:
ascertain that the workload of the first component has not exceeded a first threshold or that the bandwidth of the first component has not exceeded a second threshold; and
ascertain that the workload of the one or more second components has not exceeded a third threshold or that the bandwidth of the one or more second components has not exceeded a fourth threshold.
